(19) United States
(12) Patent Application Publication
(10) Pub. No.: US 2013/0312974 A1
(43) Pub. Date: Nov. 28, 2013

(54) Controlling hydrogen sulfide production in oilfield operations

(71) Applicant: Guy Lamont McClung, IV, Spring, TX (US)

(72) Inventor: Guy Lamont McClung, IV, Spring, TX (US)

(21) Appl. No.: 13/986,259

(22) Filed: Apr. 16, 2013

Related U.S. Application Data
(60) Provisional application No. 61/687,169, filed on Apr. 19, 2012.

(51) Int. Cl. C09K 8/60; E21B 43/26

(52) U.S. Cl. CPC C09K 8/605; E21B 43/26
USPC 166/308.1; 507/200; 507/203; 507/211; 507/217

(57) ABSTRACT

Fluids (e.g., fracturing fluids or stimulation fluids) with inhibition material for inhibiting bacteria from producing hydrogen sulfide and, in one aspect, wherein such fluid is a fracturing fluid, and methods of the use of such fluids. This abstract is provided to comply with the rules requiring an abstract which will allow a searcher or other reader to quickly ascertain the subject matter of the technical disclosure and is submitted with the understanding that it will not be used to interpret or limit the scope or meaning of the claims, 37 C.F.R. 1.72(b).

### RELATED APPLICATION

This invention and application claim the benefit of priority under the United States Patent Laws of U.S. Application Ser. No. 61/687,169, Apr. 196, 2012, which is fully incorporated herein in its entirety.

### BACKGROUND OF THE INVENTION

1. Field of the Invention

The present invention is directed to: controlling production of hydrogen sulfide by bacteria in hydrocarbon operations e.g., but not limited to, fracturing operations; to fluids used in such operations which include an effective amount of material for rendering inoperative bacterial biochemical processes that produce hydrogen sulfide; to methods for using such materials, e.g., in fracturing a formation; and to the use of such materials in equipment, structures, and tubulars used in oilfield and wellbore operations.

2. Description of Related Art

Undesirable bacteria in formations, in wells, in equipment, and in tubulars can produce hydrogen sulfide. Hydrogen sulfide is a toxic, colorless gas with a characteristic odor of rotten eggs which is considered a broad-spectrum poison, i.e., it can poison several different systems in the body, such as, but not limited to, the nervous system. Hydrogen sulfide is also corrosive to metals and is a precursor to sulfuric acid formation which is also corrosive. Corrosion due to hydrogen sulfide results in costly damage to equipment and facilities.

A variety of microorganisms are used in oilfield and wellbore operations; and the presence, spread, and enhancement of certain undesirable microorganisms are an unwanted result of some oilfiled and wellbore operations—including hydrogen-sulfide-producing bacteria, also called “sulfate-reducing bacteria,” commonly known as “SRB”. Microorganisms in oilfields or in injection water are often classified by their effects. SRBs, or “sulfate-reducing bacteria,” denitrifying bacteria (hNRB), slime-forming bacteria (NR-SOB), yeast and molds, and protozoa can be encountered in nearly any body of water present in and around an oil field. Bacteria may be found in solution (planktonic), as dispersed colonies or immobile deposits (sessile bacteria).

Bacteria can use a wide variety of nitrogen, phosphorus, and carbon compounds (such as organic acids) to sustain growth. Nitrogen and phosphorus are usually sufficiently present in the formation water to sustain bacterial growth but injection of organic nitrogen—and phosphorus-containing chemicals in fluid inserted into the formation can further increase growth potential. Biocides, also called bactericides or antimicrobials, are used in oil and gas production. Their aim is to kill microorganisms, especially bacteria, or interfere with their activity.

Bacteria in oilfield water can be aerobic or anaerobic. SRBs (desulfovibrio) bacteria are anaerobic bacteria, which are present in many waters handled in oilfield operations. SRB convert sulfate ions into hydrogen sulfide, which can lead to reservoir souring. SRB can also produce sludge or slime, which can reduce the porosity of a formation.

Hydrogen sulfide is acidic and can in turn cause sulfide scales, e.g., iron sulfides. In addition, it is often necessary to remove hydrogen sulfide from gas prior to sale. Solid deposits of bacterial colonies are called “biofilms” or “biofouling.” The presence of iron sulfide or an increase in the water soluble sulfide concentration in a flow line is a strong indicator of microbially induced corrosion (MIC); therefore it is very important to prevent the formation of biofilms on the surfaces of flow lines and other production equipment. It is similarly important to deal with both planktonic and sessile bacterial numbers.

The potential for SRB activity can be greater in the case of produced water reinjection (PWRI). Water that is reinjected can be a mixture of produced water and seawater. In such cases there is a mixture of SRB nutrients including sulfate ions, organic carbon, and nitrogen (often bound in ammonium compounds). There are SRB that can survive extremes of temperature, pressure, salinity, and pH but their growth is particularly favored in the temperature range of about 40 degrees F. to about 175 degrees F.

When the fluids used in drilling or stimulating oil or gas wells contain bacteria, the producing formations can become contaminated with the bacteria. Such contaminated formations which have been fractured can be difficult or impossible to treat. Certain prior attempts to introduce one or more bactericides into such formations to contact and kill the bacteria therein can be unsuccessful, e.g., due to the bacteria being located in or near fractures at long distances from the well bores. When treating fluids containing bactericides are pumped into such previously fractured contaminated formations, the fluids can either fail to reach the locations of the bacteria, and/or proppant materials in the previously formed fractures may be disturbed thereby reducing the production from the formation.

In some hydraulic fracturing operations, much of the fracturing fluid used is recovered. In certain formations and operations, the majority of the fracturing fluid that enters the subterranean formation is not initially recovered, but, instead, remains in the formation. This can be true for small pore-sized, low permeability formations such as gas-producing shale formations. Some shales may have unfractured permeabilities of 0.01 to 0.00001 millidarcies. Effective porosity of shales may be 0.2% or less. As a result, it may be possible to initially recover only 15% or less of a fracturing fluid, with the rest of the fracturing fluid remaining in situ.

Unrecovered fracturing fluid in a formation may provide a fertile breeding ground for the anaerobic bacteria present in the hydrocarbon-producing formation. For example, sulfate reducing bacteria (SRB), can be detrimental to both the recovery of the hydrocarbon and the hydrocarbon itself. SRB act to reduce sulfates to sulfides which are detrimental to both the formation itself, as well as to the hydrocarbon recovered.

In some hydraulic fracturing methods, fluid additives such as slickwater additives are used; e.g., in recovering shale gas. Horizontal wells can require large amounts of water, e.g., as much as 4.2 million gallons of water per well in as many as 6 to 9 fracture stages. Because of environmental concerns and fresh water availability, the flowback and produced water from such a fracturing operation are collected and used for subsequent fracture treatments. Anaerobic produced water is a good environment for sulfate reducing bacteria (SRB) and acid forming bacteria (AFB) due to its anaerobic nature (<2 ppm oxygen content) and high nutrient content (organics, free iron, etc.). Reuse of water introduces enough oxygen, e.g. through regular pumping operations, to allow aerobic bacteria to grow—e.g. slime-forming bacteria (SFB). The oxygen content is high enough for aerobic bacteria to grow, but too low to kill anaerobic bacteria. The oxygen content can cause the anaerobic bacteria to stay in a biostatic state which does not kill them but prevents them from multiplying.

When bacteria find an environment that is conducive to their growth, they can become active again and start multiplying. The anaerobic environment in a formation is ideal for growth of bacteria like SRBs and AFBs. The aerobic environment of the wellbore is conducive for SFBs. The growth of SRBs can not only lead to health and safety concerns due to increased sour gas or hydrogen sulfide production, but also to a slow souring of the reservoir. This also increases operation expenses because of corrosion (pitting, stress cracking, etc.) in surface and subsurface equipment and tubulars.

Various different methods have been attempted to prevent the growth of hydrogen-sulfide-producing bacteria and reduce operational expenses related to corrosion prevention, remediation of corrosion effects, and remediation of emulsion-like produced fluids. A variety of common biocides have been used.

There are a wide variety of known fluids used in a wide variety of oil and gas operations and in wellbore operations. There are a wide variety of known fracturing (“fracking”) fluids. Of the many patents related to these subject matters, the following listing is exemplary, but not exhaustive, and is given simply as a sampling of the available references: U.S. Pat. Nos. 8,006,759; 7,950,455; 7,921,910; 6,725,926; 7,896,068; 8,082,994; 8,061,424; 7,931,087; 7,958,937; 7,946,340; 7,087,556; 6,767,867; 8,022,015; 8,006,760; 7,972,998; 7,784,541; 7,938,185; 7,255,169; 6,776,235; 8,006,755; 8,006,754; 7,954,548; 7,931,089; 7,407,010; 4,186,802; 7,398,826; 7,942,201 and in the references and patents cited in these patents (these and all patents and patent applications cited herein incorporated fully herein for all purposes).

Hydraulic fracturing of a subterranean formation is conducted to increase oil and/or gas production. Fracturing, in certain known methods, is done by injecting a viscous fracturing fluid or a foam at a high pressure (“injection pressure”) into a well to form a fracture. As the fracture is formed, particulate material in the fluid, referred to as a “propping agent” or “proppant” is placed in the formation to maintain the fracture in a supported or “propped” condition when the injection pressure is released. Coated and/or uncoated particles are often used as proppants to keep open the fractures imposed by hydraulic fracturing upon a subterranean formation, e.g., an oil or gas bearing strata. Proppants are disclosed, e.g., in U.S. Pat. Nos. 8,006,759; 7,976,949; 7,972,997; 7,919,183; 7,902,125; 7,845,409; 7,721,803; 7,708,069; 7,703,531; 7,402,338; 7,135,231; 7,132,389; 6,528,157; 4,564,459; 4,417,989; 4,493,875; 7,153,575; and include the proppants disclosed in any other patent or application mentioned or listed herein.

### SUMMARY OF THE INVENTION

The present invention, in certain aspects, discloses a treatment of sulfate-reducing bacteria with an effective amount of inhibition material (“IM”) to inhibit or prevent the bacteria from producing hydrogen sulfide. Bacteria of concern produce hydrogen sulfide in a biochemical process involving enzyme production (the production of enzymes that produce hydrogen sulfide) and the presence of the inhibition material (“IM”) renders these biochemical processes inoperative.

In certain aspects, IM is used according to the present invention to prevent the production by SRB of the enzymes needed in the SRB hydrogen-sulfide-producing process. In certain aspects, IM is used according to the present invention so that IM is not expended in rendering the enzyme production process inoperative. In certain aspects, IM is used according to the present invention so that SRB is not killed by the IM. Herein when reference is made to using “IM according to the present invention,” it is to be understood that such usage includes, inter alia, one, two, or three of the functions and/or results listed in this paragraph.

In a fluid according to the present invention, sufficient IM is used to render inoperable the production of enzymes by an amount of SRB in the fluid or by an amount of SRB anticipated to be encountered in or by the fluid so that hydrogen sulfide production by the SRB is prevented.

In certain embodiments, when used in a fracturing fluid, sufficient IM is used to render SRB hydrogen sulfide production inoperative. This amount can be based on: an amount of SRB in the fracturing fluid; an amount of SRB anticipated to be encountered in a formation; and amount of SRB anticipated to be encountered in equipment, structures, tubulars, etc.; any of these amounts that is measured, calculated or estimated; or a therapeutic amount based on similar past situations and/or anticipated SRB level. For fracturing fluids, the IM may be added to a prepared fracturing fluid; as solid material to be added to a fluid; to solid materials to be added to a fluid; to water to be used to make up a fracturing fluid; to an additive to be added to a fracturing fluid; to a recovered fracturing fluid; to flowback; to a fluid used to pre-treat a formation to be fractured; or to a fluid used to post-treat a formation after fracturing. The IM can be added in any known way for adding solid material or liquid to a stream or to another amount of material, including, but not limited to, by pouring, mixing, injection, feeding, and pumping. The IM may be added at any suitable input point, opening, flow channel access, and inlet.

“IM” according to the present invention, includes, but is not limited to, inorganic metal salts, including, but not limited to:

Bismuth Hydroxide
Bismuth Nitrate
Bismuth Oxychloride
Bismuth Oxyhydroxy Nitrate
Bismuth Subcarbonate
Bismuth Subnitrate
Bismuth Trioxide
Cadmium Nitrate
Chromium Nitrate
Cobalt Ammonium Phosphate
Cobalt Carbonate
Cobalt Chloride
Cobalt Hydroxide
Cobalt Nitrate
Cobalt Oxide
Cobalt Phosphate
Cobalt Sulfate
Cobalt Sulfate
Copper Acetate
Copper (Basic) Nitrate
Copper Carbonate
Copper Hydroxide
Copper Iodide
Copper Nitrate
Copper Oxide
Ferric Nitrate
Iron Phosphate
Magnesium Nitrate
Manganese Acetate
Manganese Carbonate
Nickel Carbonate
Nickel Hydroxide
Nickel Nitrate
Zinc Carbonate
Zinc Nitrate
Zinc Sulfate
Zinc Oxide

In certain aspects, the IM is any suitable inorganic metal salt.

In certain aspects, the IM is any suitable scrubber media disclosed in pending U.S. patent application Ser. No. 12/202,098 filed Aug. 29, 2008.

In certain aspects, 0.5 to 100 pounds of IM are used for each 1000 gallons of fracturing fluid.

In one aspect, a fracturing fluid according to the present invention includes IM and a gelling material which may be any suitable known gelling material. In one aspect, a fracturing fluid according to the present invention includes IM and a viscosifier which may be any suitable known viscosifier. In one aspect, a fracturing fluid according to the present invention includes IM and a crosslinker material which may be any suitable known crosslinker material. In one aspect, a fracturing fluid according to the present invention includes IM and a breaker material which may be any suitable known breaker material. In one aspect, a fracturing fluid according to the present invention includes IM and a pH adjusting material which may be any suitable known pH adjusting material. Optionally, any such fracturing fluid contains a buffer composition; e.g., but not limited to, a salt or a plurality of salts,

The present invention discloses formation fracturing methods in which a formation is fractured using a fracturing fluid according to the present invention (any disclosed herein). In certain aspects, such a fracturing fluid has IM and any of the known additives and known components of known fracturing fluids.

The present invention, in certain aspects, provides aqueous-based treatment fluids. In certain particular embodiments, the present invention discloses improved treatments fluids that are the fluids of U.S. application Ser. No. 12/783,715 (said application incorporated fully herein for all purposes), but with an improvement or improvements according to the present invention; e.g., but not limited to, inclusion of IM according to the present invention in a treatment fluid or composition of the application Ser. No. 12/783,715.

The present invention discloses, in certain aspects, a method of treating a subterranean formation using a well-treating fluid with IM according to the present invention, the subterranean formation penetrated by a wellbore, the method including preparing the well-treating fluid with IM and introducing the well-treating fluid to the wellbore at a temperature and a pressure sufficient to treat the subterranean formation.

A product is also provided including a well-treating fluid for use in treating subterranean formations with the well-treating fluid including IM according to the present invention.

The present invention, in certain aspects, provides aqueous-based treatment fluids with IM. In certain particular embodiments, the present invention discloses improved treatments fluids that are the fluids of U.S. application Ser. No. 10/146,326 (said application incorporated fully herein for all purposes), but with an improvement or improvements according to the present invention; e.g., but not limited to, with IM according to the present invention in a treatment fluid or composition of the application Ser. No. 10/146,326.

Fluids according to the present invention with IM according to the present invention can be prepared and/or processed using any suitable known technique or method for doing these things; including, but not limited to the methods, mixing procedures, and techniques disclosed in U.S. Pat. Nos. 4,828,034; 7,104,328; 7,048,432; 5,426,137; 5,382,411; and 4,466,890 and in the references cited in these patents; and U.S. Application Publication No. 2003/0008780—all said patents, said references, and said application incorporated fully herein for all purposes.

In one aspect, the present invention discloses an “on-the-fly” process to make a well treating fluid according to the present invention. In one such process, a liquid slurry including IM according to the present invention, gelling material, a carrier fluid, and, optionally, suspending agents is prepared remote from the wellbore site. The carrier fluid is, in certain aspects, a diesel fuel or mineral oil. The suspending agents, which are used to suspend the slurry, may be inorganic and non-soluble in water.

This liquid slurry is then taken to the wellbore site and mixed in hydration tanks with water to form the treating fluid. Optionally, IM is not in the liquid slurry and the IM is added to the contents of the hydration tanks.

These hydration tanks are also called on-the-fly hydration units. In these on-the-fly hydration units, the gelling material in the liquid slurry is allowed to hydrate for a sufficient time period, e.g., one up to ten minutes, up to twenty minutes, or between about seven to ten minutes. Optionally, a cross-linker and any other additives are then added to the liquid slurry and then the material is introduced to the wellbore.

It is within the scope of the present invention to make a well treating fluid according to the present invention as described in U.S. patent application Ser. No. 10/146,326, using the guar or guar material referred to therein or a gelling material as described in U.S. Application Ser. No. 61/685,404 filed Mar. 16, 2012. Any such well treating fluid according to the present invention has IM according to the present invention and may include additional components that may be admixed to the well treating fluids described above. For example, conventional additives such as pH control agents, bactericides, clay stabilizers, surfactants, breakers, crosslinkers, buffers, and the like, which do not interfere with the other components, or adversely affect the treatment, may also be used. Any such well treating fluid according to the present invention may include with the IM according to the present invention known gelling material, for example, but not limited to, guar or guar derivatives.

The present invention provides stimulation fluids that include IM. It is to be understood that in any disclosure herein referring to a “fracturing” fluid that that fluid may be used as a stimulation fluid.

It is within the scope of the present invention to provide IM in any desired amount in any of the fluids, streams, equipment, conduits, apparatuses, and tubulars disclosed in the following patents and in references cited therein, and the provision of the IM can be done by any suitable method, e.g., but not limited to, pouring, mixing, feeding, pumping, and injecting: U.S. Pat. Nos. 8,006,759; 7,950,455; 7,921,910; 6,725,926; 7,896,068; 8,082,994; 8,061,424; 7,931,087; 7,958,937; 7,946,340; 7,087,556; 6,767,867; 8,022,015; 8,006,760; 7,972,998; 7,784,541; 7,938,185; 7,255,169; 6,776,235; 8,006,755; 8,006,754; 7,954,548; 7,931,089; 7,407,010; 4,186,802; 7,398,826; 7,942,201; 8,006,759; 7,976,949; 7,972,997; 7,919,183; 7,902,125; 7,845,409; 7,721,803; 7,708,069; 7,703,531; 7,402,338; 7,135,231; 7,132,389; 6,528,157; 4,564,459; 4,417,989; 4,493,875; 7,153,575; and in the references and patents cited in these patents.

In certain fracturing fluids according to the present invention, water and sand are the primary components of the fluid and in other aspects water and sand are present along with other materials (e.g., any additive described herein). It is within the scope of the present invention for the water to have IM, the sand to have IM, and/or for the other materials to have IM (any IM according to the present invention).

It is within the scope of the present invention for this IM (in water, sand, or in other materials) to be added in a solution (e.g., an aqueous solution) and/or for the IM to be added as a dried particulate. It is within the scope of the present invention for the IM as dry particulate material to be added to dry sand and/or for the IM as dry particulate material to be added to other materials that are dry and then for the combination of IM and sand and/or the combination of IM and other material to be added to fluid, e.g., to water or to a fracturing fluid (with or without water).

In one particular aspect, a fracturing fluid according to the present invention includes a guar (or a guar derivative and/or a guar substitute), and, prior to the guar being dried, the IM is added to it, in either dry particulate form or in fluid form (e.g., in an aqueous solution). In one aspect, guar thus combined with IM is then combined with a fluid, e.g., but not limited to, water.

In certain aspects, IM according to the present invention is included in a coating of a proppant, either for almost instantaneous activity upon arrival at a location of interest or for delayed or residual effect.

Accordingly, the present invention includes features and advantages believed to enable it to advance hydrogen sulfide control technology and earth fracturing operations. Characteristics and advantages of the present invention described above and additional features and benefits will be readily apparent to those skilled in the art upon consideration of the following detailed description of preferred embodiments and referring to the accompanying drawings.

What follows are some of, but not all, the objects of this invention. In addition to the specific objects stated below for at least certain preferred embodiments of the invention, there are other objects and purposes which will be readily apparent to one of skill in this art who has the benefit of this invention's teachings and disclosures.

It is, therefore, an object of at least certain embodiments of the present invention to provide: New, useful unique, efficient, nonobvious methods for controlling the production of hydrogen sulfide by bacteria in wellbore opeations; and

It is, therefore, an object of at least certain embodiments of the present invention to provide: New, useful unique, efficient, nonobvious control of hydrogen sulfide production by bacteria in fracturing operations;

To one of skill in this art who has the benefits of this invention's teachings, other purposes will be appreciated from the descriptions herein when taken in conjunction with the drawings. The detail in these descriptions is not intended to thwart this patent's object to claim this invention no matter how others may later disguise it by variations in form, changes, or additions of further improvements.

It will be understood that the various embodiments of the present invention may include one, some, or any possible combination of the disclosed, described, and/or enumerated features, aspects, and/or improvements and/or technical advantages and/or elements in claims to this invention.

### BRIEF DESCRIPTION OF THE SEVERAL VIEWS OF THE DRAWINGS

A more particular description of embodiments of the invention briefly summarized above may be had by references to the embodiments which are shown in the drawings which form a part of this specification.

These drawings illustrate embodiments preferred at the time of filing for this patent and are not to be used to improperly limit the scope of the invention which may have other equally effective or legally equivalent embodiments. In the appended figures, similar components and/or features may have the same numerical reference label.

FIG. 1 is a schematic view of a system according to the present invention.

FIG. 2 is a schematic view of a system according to the present invention.

FIG. 3A is a schematic representation of coiled tubing or tubing inside a horizontal wellbore.

FIG. 3B is a schematic representation of a gel according to the present invention being introduced into the wellbore of FIG. 3A.

FIG. 3C is a schematic representation of a first fracture in the formation of FIG. 3A.

FIG. 4 is a schematic representation of the coiled tubing or tubing of FIG. 3A pulled back to a second fracturing interval according to the present invention;

FIG. 5 is a schematic representation of a second fracture at the second fracturing interval of FIG. 3A.

FIG. 6 is a schematic representation of the wellbore of FIG. 3A with the tubing removed and fracturing completed.

FIG. 7 is a schematic representation of the wellbore of FIG. 3A being flowed back following breaking of the gel plug according to the invention.

FIG. 8 is a schematic view of a system according to the present invention.

FIG. 9 is a schematic view of a system according to the present invention.

FIG. 10A is a schematic cross-section view of a proppant according to the present invention.

FIG. 10B is a schematic cross-section view of a proppant according to the present invention.

Certain embodiments of the invention are shown in the above-identified figures and described in detail below. Various aspects and features of embodiments of the invention are described below.

Any combination of aspects and/or features described below can be used except where such aspects and/or features are mutually exclusive.

It should be understood that the appended drawings and description herein are of certain embodiments and are not intended to limit the invention.

On the contrary, the intention is to cover all modifications, equivalents and alternatives falling within the spirit and scope of the invention as defined by the appended claims.

In showing and describing these embodiments, like or identical reference numerals are used to identify common or similar elements. The figures are not necessarily to scale and certain features and certain views of the figures may be shown exaggerated in scale or in schematic in the interest of clarity and conciseness.

As used herein the various portions (and headings), the terms “invention”, “present invention” and variations thereof mean one or more embodiments, and are not intended to mean the claimed invention of any particular embodiment.

So long as they are not mutually exclusive or contradictory any aspect or combination of aspects or features of any embodiment disclosed herein may be used in any other embodiment disclosed herein. The present invention includes a variety of aspects, which may be combined in different ways.

Further, this description should further be understood to support and encompass descriptions and claims of all the various embodiments, systems, techniques, methods, devices, and applications with any number of the disclosed elements, with each element alone, and also with any and all various possible permutations and combinations of all elements in this or any subsequent application.

Specific details are given in the following description to provide a thorough understanding of the embodiments. However, it will be understood by one of ordinary skill in the art that the embodiments may be practiced without these specific details.

Individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged.

A process may be terminated when its operations are completed, but could have additional steps not discussed or included in a figure. Furthermore, not all operations in any particularly described process may occur in all embodiments.

Embodiments of the invention may be implemented, at least in part, either manually or automatically. Manual or automatic implementations may be executed, or at least assisted, through the use of machines, hardware, software, firmware, middleware, microcode, hardware description languages, or any combination thereof.

When implemented in software, firmware, middleware or microcode, the program code or code segments to perform the necessary tasks may be stored in a machine readable medium. A processor(s) may perform the necessary tasks.

### DETAILED DESCRIPTION OF THE INVENTION

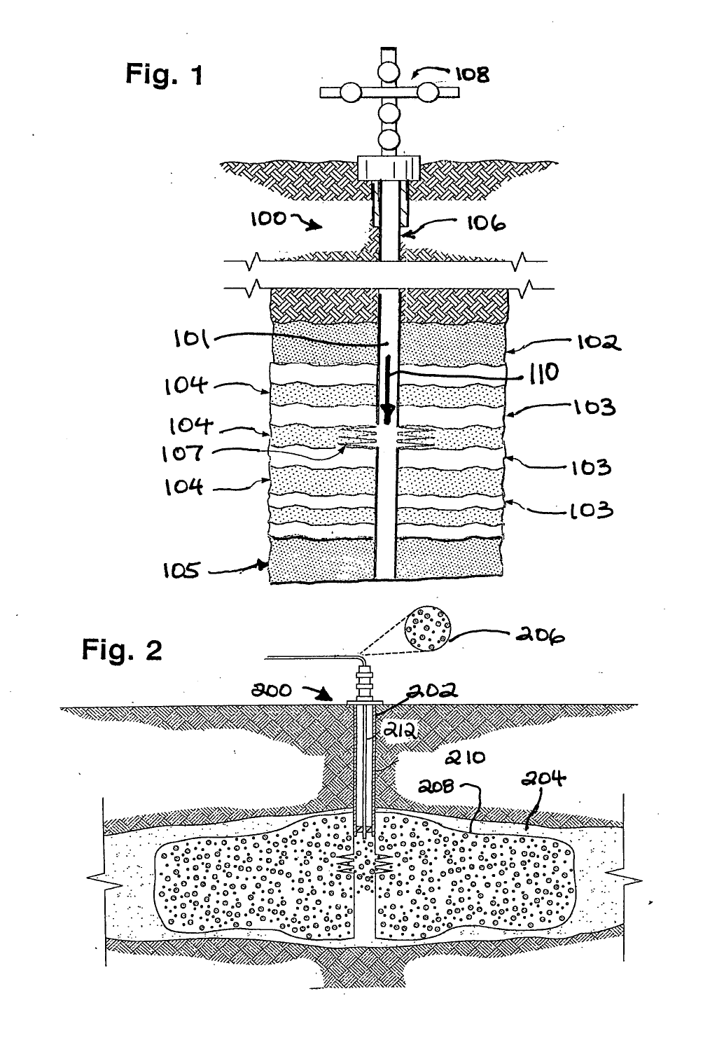

FIG. 1 shows a system 100 for fracturing a formation using fracking fluids according to the present invention; i.e., a fluid with IM according to the present invention, e.g., any disclosed herein. A wellbore 101 is drilled through a multi-layered reservoir having lower effective stress (hydrocarbon-bearing) layers 103 and higher effective stress (non-hydrocarbon-bearing) layers 104. The number and distribution of these layers varies both within a reservoir and between different reservoirs. The multi-layered reservoir is bounded above and below by higher effective stress layers 102 and 105.

A fracturing treatment 110 according to the present invention (which includes IM) is pumped into an interval 107 that is to be fractured (this treatment 110 may be any fluid according to the present invention with IM).

A conduit 106 is installed in the wellbore 101, through which the fracturing treatment 110 is pumped. This conduit 106 could be, but is not limited to, production casing, production tubing, coiled tubing or a “frac string” (a temporary conduit specifically designed for fracturing). Packers, or straddle packers may be used along with such conduits to isolate the casing openings at the desired fracture location. Methods for re-establishing pressure communication with interval 107 following cementing of the conduit 106 include, but are not limited to, perforating, sand jetting, or the opening of a fracturing valve (installed along with the conduit prior to cementing or along with a temporary “frac string”).

An open-hole in the higher effective stress section that itself provides pressure communication with an impervious section is included as a method of “re-establishing pressure communication.”

The fracturing treatment 110 is pumped by pump apparatus (not shown), through a wellhead 108, down the conduit 106 and into the formation with pressure communication established with the interval 107.

In certain aspects, an increase in well-bore pressure, so as to cause the subterranean formation to fracture is achieved by pumping the fracturing treatment into the well-bore.

In one aspect, a fracturing treatment 110 may include fluid and proppants and/or additives. The fluid may contain additives including, but not limited to, cross-linkers, breakers, surfactants, buffers, friction reducers, fluid loss additives and foaming agents. Any type of proppant may be used, including, but not limited to, sand, ceramic, bauxite or plastic proppant. The proppant may be deployed in any suitable known manner, e.g., but not limited to, by mixing it into the fracturing fluid during pumping. It is within the scope of the present invention for any of these proppants or additives to include IM therein or thereon.

The present invention provides improvements to the subject matter of U.S. Pat. No. 7,938,185 (incorporated fully herein for all purposes). In certain aspects, the present invention provides methods for hydraulically fracturing subterranean formations penetrated from an earth surface by a cased well, at least one formation being a higher effective stress formation and at least one formation being a lower effective stress formation, the method including: a) establishing fluid communication between an inside of the cased well and the higher effective stress formation; b) injecting a fracturing fluid (any according to the present invention with IM) into the cased well at a pressure sufficient to force the fracturing fluid into contact with the higher effective stress formation at a pressure sufficient to cause the higher effective stress formation to fracture; c) continuing injection of the fracturing fluid into the higher effective stress formation at a pressure and in an amount sufficient to cause the fracture in the higher effective stress formation to grow and extend into at least one lower effective stress formation; and, d) discontinuing the injection of the fracturing fluid. In one aspect, the IM is spread through all the equipment through which the fluid flows and throughout the formation.

FIG. 2 shows a system 200 for fracturing a formation of interest 204 using a fracturing treatment according to the present invention with IM. The system 200 includes a wellbore 202 in fluid communication with a formation of interest 204, which may be any formation wherein fluid communication between a wellbore and the formation is desirable, including a hydrocarbon-bearing formation, a water-bearing formation, a formation that accepts injected fluid for disposal, pressurization, or other purposes, or any other formation understood in the art.

The system 200 further includes a fracturing slurry 206 (shown enlarged in the circle labeled 206) that includes any fracturing fluid according to the present invention with IM. The system 200 includes a pumping device 212 for pumping the fracturing slurry 206 to create a fracture 208 in the formation of interest 204 with the slurry 206.

The aqueous base fluid used in the treatment fluids and compositions of the present invention may be one or more aqueous fluids. For example, the aqueous base fluid may include, but is not limited to, seawater, fresh water, saltwater (e.g., water containing one or more salts dissolved therein), brine (e.g., saturated saltwater), weighted brine (e.g., an aqueous solution of sodium bromide, calcium bromide, zinc bromide and the like), or any combination thereof. Generally, the aqueous fluid may be from any source, provided that it does not contain components that might adversely affect the stability and/or performance of the treatment fluids or compositions of the present invention. In certain embodiments, the density of the aqueous base fluid can be increased, among other purposes, to provide additional particle transport and suspension in the treatment fluids and compositions of the present invention.

In certain embodiments, the pH of the aqueous base fluid may be adjusted (e.g., by a buffer or other pH adjusting agent), inter alia, to facilitate hydration of a gelling agent, to activate a crosslinking agent, and/or to reduce the viscosity of the treatment fluid (e.g., activate a breaker, deactivate a crosslinking agent). In these embodiments, the pH may be adjusted to a specific level, which may depend on, among other factors, the types of gelling agents, and/or crosslinking agents in the treatment fluid.

In certain aspects, the pH of the fluid may be any desired pH, and, in one aspect, is between 10 to 10.5 or is about or less when a stable gelled fluid is desired. Suitable pH adjusting agents include any compounds capable of altering the pH of the treatment fluid.

Examples of such compounds that may be used include, but are not limited to, formic acid, fumaric acid, acetic acid, maleic acid, acetic anhydride, hydrochloric acid, sodium hydroxide, potassium hydroxide, lithium hydroxide, various carbonates, any combination thereof, or any other commonly used pH control agent that does not adversely react with the gelling agent, crosslinker, or buffering agent to prevent its use in accordance with a method of the present invention. When used, the pH-adjusting compound is, in certain aspects, present in an effective amount and/or present in a treatment concentrate of the present invention in an amount in the range of from about 0.5% to about 10% by weight of the aqueous fluid therein.

In another embodiment, the pH-adjusting material or compound is generally present in a treatment fluid of the present invention in an amount in the range of from about 0.01% to about 0.3% by weight of the aqueous fluid therein.

In an embodiment, the pH adjusting agent comprises sodium hydroxide and is present in an amount from about 0.01 gallons per thousand gallons of treatment fluid (“gpt”) to about 2 gpt.

In an embodiment, gelling material is an amount of guar, hydroxypropylguar, carboxymethylhydroxypropylguar, carboxymethylguar, arboxymethylcellulose, carboxymethylhydroxy-ethylcellulose, galactomannan gums, modified or derivative galactomannan gums, suitable polymers, and cellulose derivatives and any combination thereof.

The gelling material may be present in the treatment fluid according to the present invention in an amount in the range of from about 10 to about 100 pounds per 1000 gallons of the aqueous base fluid, or from about 30 to about 50 pounds per 1000 gallons of aqueous base fluid. In one aspect the aqueous base fluid is present in the treatment fluid in at least an amount sufficient to hydrate the gelling agent.

The treatment fluids of the present invention may include a suitable crosslinking agent, inter alia, to crosslink the gelling material, e.g., to crosslink at least a portion of the molecules of the gelling material to form a crosslinked gelling material. The term “crosslinking agent” includes any molecule, atom, or ion that is capable of forming one or more crosslinks between molecules of the crosslinkable gelling material and/or between one or more atoms in a single molecule of the crosslinkable gelling material. The crosslinking agent in the treatment fluids of the present invention may be a metal ion that is capable of crosslinking at least two molecules of the crosslinkable gelling material.

Examples of suitable crosslinking agents include, but are not limited to, borate ions and zirconium ions. These ions may be provided by providing any compound that is capable of producing one or more of these ions; examples of such compounds include, but are not limited to, boric acid, disodium octaborate tetrahydrate, sodium diborate, pentaborates, ulexite, colemanite, zirconium oxychloride, chelates of zirconium, derivatives thereof, and combinations thereof. In certain embodiments of the present invention, the crosslinking agent may be present in a gelling material, wherein at least a portion of the molecules of the gelling material are crosslinked by the crosslinking agent.

Suitable crosslinking agents may be present in the treatment fluids of the present invention in an amount sufficient to provide, inter alia, the desired degree of crosslinking between molecules of the gelling material according to the present invention. In certain embodiments, the crosslinking agent may be present in the treatment fluids of the present invention in an amount in the range of from about 1 part per million (“ppm”) to about 1,000 ppm by weight of the treatment fluid. In certain exemplary embodiments, the crosslinking agent may be present in the treatment fluids of the present invention in an amount in the range of from about 10 ppm to about 500 ppm by weight of the treatment fluid.

In an embodiment, the crosslinking agent may be capable of crosslinking the gelling material at a pH of about 10 or less. In an embodiment, the crosslinking agent may be capable of crosslinking the gelling material at a temperature ranging from about 200 degrees F. to about 325 degrees F., or alternatively at a temperature ranging from about 215 degrees F. to about 300 degrees F.

The crosslinking agents may be provided or used in any suitable form. For instance, the crosslinking agents may be a liquid, a gel, an emulsion, or a solid. In some embodiments, a crosslinking agent may be dissolved, suspended, or emulsified in a liquid. The crosslinking agent utilized in the present invention may be capable of causing delayed crosslinking of the gelling material for pipe transit times greater than 5 minutes. Thus, the delay in crosslinking exhibited by compositions of the present invention may be about 5 minutes or more. A delayed release may be desirable when a subterranean operation involves high temperature conditions, and in a deep well or in a well requiring a long pump time.

In some embodiments, the crosslinking agent may be capable of causing an accelerated crosslinking of the gelling material. Such acceleration may be desirable due to the conditions of the treatment fluid and the expected conditions within the subterranean formation. For example, the temperature of the formation may make it desirable to include an accelerated crosslinking agent in the treatment fluid. Suitable accelerated crosslinking agents may include, but are not limited to, instant borate, instant zirconium, or any combination thereof. The composition of the crosslinking agent and/or the buffering composition can affect the rate of crosslinking of the gelling material. In certain embodiments, the crosslinking agents of the present invention may be encapsulated or enclosed within an outer coating that is capable of degrading at a desired time.

The treatment fluids of the present invention may include a buffer composition, which may improve the shear recovery of the treatment fluid. In general, a fluid can regain viscosity after exiting a high-shear region in a wellbore tubular and entering a low-shear environment in a subterranean environment. The shear recovery of a fluid may be measured by the viscosity of the fluid at a low shear rate after experiencing a high shear event. For example, a high shear event may be an event with a shear rate of at least 375 sec for at least 2 minutes followed by a reduced shear rate. Such a high shear event may be referred to as a super shear event, and in some embodiments may have a known shear.

For fracturing operations, a known low shear rate is often used as a standard for measuring low shear viscosity of a fracturing fluid. In an embodiment, the shear recovery may be measured in accordance with the known American Petroleum Institute's testing procedure when used in combination with a fluid including a buffer composition refers to a fluid viscosity that is greater than the viscosity of a fluid without a buffer composition after a high shear event. In an embodiment, the viscosity of a fluid with a buffer composition may be at least 100% greater than the viscosity of a fluid without the buffer composition after a high shear event.

In another embodiment, the viscosity of a fluid with a buffer composition may be at least 200%, or alternatively 300% greater than the viscosity of a fluid without the buffer composition after a high shear event.

When used, a buffer composition is, in one aspect, present in the treatment fluids according to the present invention in an amount in the range of from about 1 pound per 1000 gallons of the treatment fluid to about 50 pounds per 1000 gallons of the treatment fluid. For example, a combination of potassium carbonate and sodium bicarbonate may be used with an aqueous based treatment fluid. In this embodiment, the total amount of buffer composition in the treatment fluid may fall within the range listed above, and the amount of each component of the combination may be evenly distributed or there may be more or less of one component relative to the other.

For example, in an embodiment using potassium carbonate and sodium bicarbonate, the treatment fluid may comprise from about 0.2 to about 10 pounds of potassium carbonate per 1000 gallons of treatment fluid and from about 0.8 to about 40 pounds per 1000 gallons of sodium bicarbonate. In another embodiment using potassium carbonate and sodium bicarbonate, the treatment fluid may comprise from about 1 to about 5 pounds of potassium carbonate per 1000 gallons of treatment fluid and from about 5 to about 20 pounds per 1000 gallons of sodium bicarbonate.

The treatment fluids of the present invention optionally may include proppants, e.g. such as known suitable proppant particulates or gravel particulates, including, but not limited to, sand, bauxite, ceramic materials, glass materials, polymer materials, Teflon (trademark) materials, nut shell pieces, cured resinous particulates comprising nut shell pieces, seed shell pieces, cured resinous particulates comprising seed shell pieces, fruit pit pieces, cured resinous particulates comprising fruit pit pieces, wood, composite particulates, and combinations thereof, with or without a coating, with or without suitable binder(s) and filler material(s), e.g., but not limited to, silica, alumina, fumed carbon, carbon black, graphite, mica, titanium dioxide, meta-silicate, calcium silicate, kaolin, talc, zirconia, boron, fly ash, hollow glass microspheres, solid glass, and combinations thereof.

The particulate size generally may range from about 2 mesh to about 400 mesh on the U.S. Sieve Series; however, in certain circumstances, other sizes may be desired and will be entirely suitable for practice of the present invention. In particular embodiments, preferred particulates size distribution ranges are one or more of 6/12, 8/16, 12/20, 16/30, 20/40, 30/50, 40/60, 40/70, or 50/70 mesh. It should be understood that the term “particulate,” as used in this disclosure, includes all known shapes of materials, including substantially spherical materials, fibrous materials, polygonal materials (such as cubic materials), and mixtures thereof. Moreover, fibrous materials, that may or may not be used to bear the pressure of a closed fracture, may be included in certain embodiments of the present invention. IM may also be used in the sizes mentioned in this paragraph.

The treatment fluid of the present invention and/or a composition according to the present invention can also include a gel breaker which “breaks” or diminishes the viscosity of the fracturing fluid so that it is more easily recovered from the fracture during clean up. Examples of gel breakers suitable for use with the inventive fracturing fluids include oxidizing agents, enzymes, acids, and any combination thereof, with oxidizing agents being the most preferred.

In an embodiment, the gel breaker may be a delayed gel breaker. Examples of delayed gel breakers that may be used include, but are not limited to, various lactones, esters, encapsulated acids and slowly soluble acid generating compounds, oxidizers which produce acids upon reaction with water (such as polyesters or polyorthoesters), water reactive metals such as aluminum, lithium and magnesium and the like. In certain embodiments, the delayed gel breaker is an ester. Where used, the gel breaker may be present in the treating fluid in an amount in the range of from about 0.01% to about 1% by weight of the aqueous fluid therein.

Alternatively, any of the conventionally used delayed breakers employed with metal ion crosslinkers may be used, for example, oxidizers such as sodium chlorite, sodium hypochlorite, sodium bromate, sodium persulfate, ammonium persulfate, encapsulated sodium persulfate, potassium persulfate, or ammonium persulfate and the like as well as magnesium peroxide. Enzyme breakers that may be employed include alpha and beta amylases, amyloglucosidase, invertase, maltase, cellulase and hemicellulase. The specific breaker or delinker used, whether or not it is encapsulated, as well as the amount thereof employed will depend upon the breaking time desired, the nature of the polymer and crosslinking agent, formation characteristics and conditions and other factors.

The treatment fluids of the present invention optionally may include one or more of a variety of well-known additives which do not adversely react with the treatment fluids. Exemplary additives may include, but are not limited to, gel stabilizers, fluid loss control additives, acids, corrosion inhibitors, catalysts, clay stabilizers, biocides, bactericides, friction reducers, gas, surfactants, solubilizers, pH adjusting agents, and the like. According to the present invention, IM may be in or on any of these additives.

The treatment fluids of the present invention can be prepared by dissolving a gelling material in an aqueous base fluid to form a gelled aqueous fluid, optionally along with a buffer composition, and then, optionally, combining with the gelled aqueous base fluid a crosslinking agent, capable of causing crosslinking of the gelling material. The gelling material is added to the aqueous base fluid as either a solid or a liquid gel concentrate in a pre-hydrated or slurried form using conventional mixing and pumping equipment. The delayed crosslinking composition may be combined with the gelled aqueous base fluid. The buffer composition may generally be combined with the aqueous base fluid prior to the addition of the gelling material and crosslinking agent, though it can be added in a different order if required. IM can be added to the fluid at any step, before any step, or after any step.

The buffer composition may be a part of the liquid gel concentrate used to add the gelling material. As is understood by those skilled in the art, the crosslinker may be pumped and metered into the gelled aqueous fluid as the gelled aqueous fluid is pumped into the well bore. Additional components may be added into the treatment fluid with the gelling material or on the fly as the gelled aqueous base fluid is pumped into the well bore.

The present invention provides improvements to the subject matter of U.S. application Ser. No. 12/783,715 filed May 20, 2010 (incorporated fully herein for all purposes). In certain aspects, the present invention provides a method including: providing a treatment fluid including IM and contacting a subterranean formation with the treatment fluid. In certain aspects, such a treatment fluid further includes a gelling agent, an aqueous base fluid, optionally a buffer composition e.g., a plurality of salts, a pH adjusting agent and/or optionally a crosslinking agent.

The gelling agent may be at least one of: guar, hydroxypropylguar, carboxymethylhydroxypropylguar, carboxymethylguar, carboxymethylcellulose, carboxymethylhydroxy-ethylcellulose, and any combination thereof; and the gelling agent may be present in the treatment fluid in an amount in the range of about 10 to about 100 pounds per 1,000 gallons of the aqueous base fluid.

The IM may be any IM disclosed herein and it may be present in any amount disclosed herein, determined in any way disclosed herein. In certain aspects, the IM is present in an effective amount to inhibit hydrogen sulfide production by SRB. The IM may be present in the treatment fluid in an amount in the range of about 1 to about 50 pounds per 1,000 gallons of the treatment fluid; in an amount of about 1 pound of IM per 1,000 gallons of treatment fluid; in an amount of about 50 pounds of IM per 1,000 gallons of treatment fluid; IM present from about 0.001 to about 2.0% by weight of treatment fluid; IM present as about 5 to 25 parts per million of the treatment fluid; IM present as about 100 parts per million of the treatment fluid; IM present as about 250 parts per million of the treatment fluid; or IM present as about 500 parts per million of the treatment fluid.

In one embodiment, 0.001 of 1 gallon of IM fluid (about 50% water, about 50% IM, by weight) is mixed with 1000 gallons of fracturing fluid. In certain aspects, 1 gallon of fluid according to the present invention with IM is: about 15% by weight IM; includes about 12 pounds of IM; or is between 7 to 25 ppm IM.

The present invention provides a method including: providing a treatment fluid with an effective amount of IM to inhibit SRB production of hydrogen sulfide, a gelling agent, an aqueous base fluid, a buffer composition, and a crosslinking agent; introducing the treatment fluid into a subterranean formation at a rate and pressure whereby a fracture is formed in the subterranean formation; optionally allowing the treatment fluid to break; and optionally recovering at least a portion of the treatment fluid.

The present invention provides a composition for a fracturing fluid including an amount of IM effective to inhibit hydrogen sulfide production by SRB; and optionally a gelling agent, an aqueous base fluid, a buffer composition and/or a crosslinking agent. Suitable aqueous base fluids include seawater, fresh water, saltwater, brine, weighted brine, and any combination thereof.

It is within the scope of the present invention to provide a fracturing fluid with IM according to the present invention that may be left in a fractured formation for a period of time and, in certain aspects, for an extended period of time. It is within the scope of the present invention to provide a multifunctional fracturing fluid with IM that may be left in a fractured formation for an extended period of time. The present invention provides improvements to the subject matter of U.S. Pat. No. 7,256,160 including the addition of IM to any fluid in this patent (any IM according to the present invention).

Certain fracturing methods using a fracturing fluid according to the present invention with IM according to the present invention include, but is not limited to the following procedures: a. Pumping a fracturing fluid composition with IM down a wellbore to a subterranean formation; b. Permitting the fracturing fluid composition to gel; and c. Pumping the fracturing fluid composition against the subterranean formation at sufficient rate and pressure to fracture the formation. Optionally such a method may include: d. Breaking the fracturing fluid composition gel; e. Leaving the fracturing fluid composition in the formation for a relatively extended period of time; and/or f. Subsequently flowing the fracturing fluid composition out of the formation.

By leaving the fracturing fluid in the formation for a relatively extended period of time is meant that the fluid whose gel has been broken is not flowed back out of the well bore (or produced) relatively soon or even immediately after the gel is broken. In one non-limiting embodiment of the invention, the fracturing fluid having reduced viscosity is left in the formation at least 28 days; in another embodiment, at least a week; and in another embodiment, at least 10 days. The broken fluid could remain in the formation for months, e.g., but not limited to, up to nine months or longer.

Certain fracturing fluid compositions according to the present invention have the following general formula: water and IM according to the present invention. Such a composition may also include one, some or all of:

i) at least one hydratable polymer;
ii) at least one water wetting control agent;
iii) at least one salt clay control agent;
iv) at least one biocide;
v) at least one scale inhibitor;
vi) at least one breaking agent; and/or
vii) an organic clay control agent.

In certain aspects, the present invention provides methods in which a fluid with IM according to the present invention is introduced into a formation after a fracturing operation in the location of the fracture thus treating the location to treat SRB present there.

In certain aspects, the present invention provides methods in which a fluid with IM according to the present invention is introduced into a formation before a fracturing operation in the location of the intended initiation of a fracture thus treating the location to treat SRB present there. In certain aspects, this fluid is an aqueous fluid and a desired amount of IM is used. Then it is within the scope of the present invention to fracture the formation using a fracture fluid with IM according to the present invention.

In other aspects, methods are provided for treating a previously-fractured SRB bacteria-containing subterranean formation penetrated by a well bore whereby said SRB bacteria are inhibited from producing hydrogen sulfide by using a fluid with IM according to the present invention to treat the fractured formation. Such a method may include: mixing a fluid with IM according to the present invention with a carrier fluid in an amount effective to inhibit production of hydrogen sulfide by SRB contained in the formation when the resultant mixture is pumped thereinto (optionally, the carrier fluid having high fluid loss characteristics); pumping the mixture into the formation through a well bore so that SRB contained in the fractured part of the formation and/or in near-well bore portions of the formation are contacted with IM. Additionally, such a method may also include: pumping a mixture with IM into the formation through the well bore at a rate and pressure sufficient to refracture the formation and thereby cause the IM to be distributed throughout the formation and to contact at least a portion of any SRB, and in one aspect substantially all SRB, contained therein. In certain aspects (and as may be true for any fluid herein with IM), the IM in a carrier fluid may be in an amount in the range of from about 0.1% to about 0.0001% by weight of the resulting IM-carrier fluid mixture. Such mixtures and such carrier fluids may be aqueous fluids.

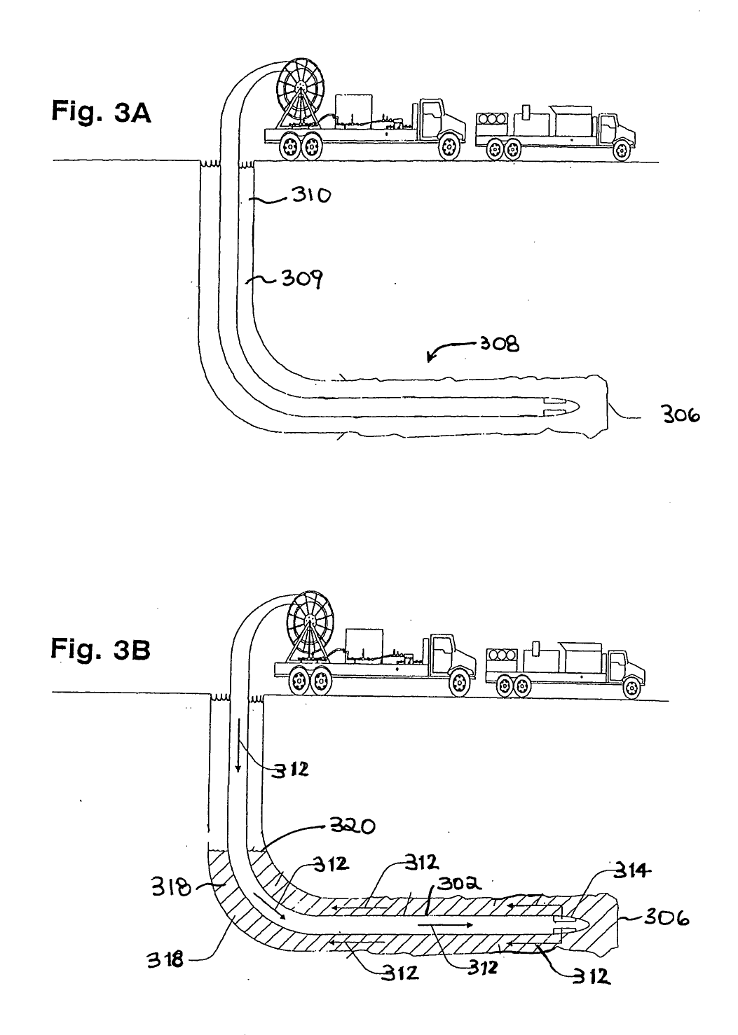

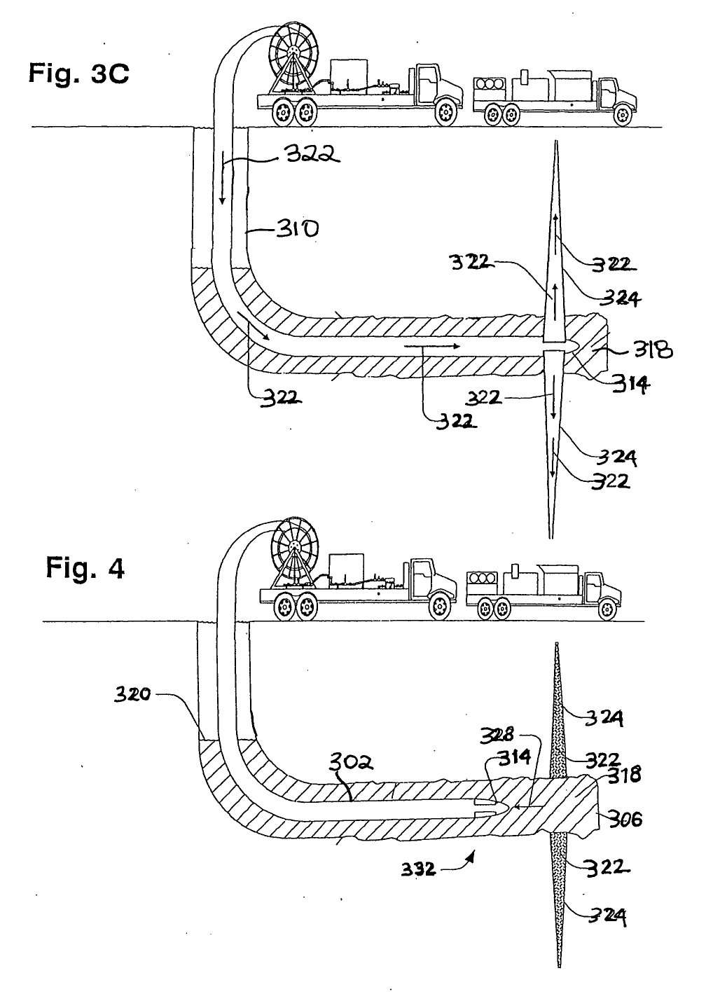

With reference to FIGS. 3A-7, in one embodiment of the invention, wellbore jointed tubing or coiled tubing 302 (see FIG. 3B) is run into a well casing 310 and an open hole formation 308 below this casing to a depth where a first fracturing treatment is to be initiated. In a vertical well this can be at a formation nearest the bottom of the well. In a horizontal well this can be at a location closest to a toe 306 of the horizontal section.

After the tubing 302 has been placed at the desired location, the wellbore 310, if not already full, is filled with an annulus fluid 309 which may be water, a hydrocarbon fluid, or any suitable fluid that can fill the wellbore 310. Any or all of these fluids may contain IM according to the present invention (any IM disclosed herein suitable for this task and this location). In certain embodiments, this fluid is incompressible and has no viscosity increasing materials or chemicals added to it.

After the wellbore 310 is filled with the annulus fluid, the entire wellbore 310 or a part thereof, is filled with a viscous gel 312 by circulating the gel 312 down the tubing 302 and out through a bottomhole apparatus diverting tool 314 as shown in FIG. 3B. The gel 312 may be any suitable known gel, optionally with IM according to the present invention (any IM disclosed herein suitable for this task and this location). The gel 312 displaces the annulus fluid 309 previously placed in the well 310.

After introduction of the gel 312 into the wellbore, the viscosity of the gel 312 increases over time (e.g., about a half an hour) to a maximum viscosity and forms a gel plug 318 in the wellbore. In the embodiment of FIG. 3B, the wellbore is filled with gel to a level indicated by 320. The gel plug 318 does not solidify and permits the tubing 302 to pass through it.

Referencing to FIG. 3C, following the formation of the gel plug 318, a fracturing fluid 322 with IM according to the present invention (any IM disclosed herein suitable for this task and this location) (or other suitable stimulation fluid with IM according to the present invention, any IM disclosed herein suitable for this task and this location)) is pumped down the tubing 302 and is directed laterally against the formation. The fracturing fluid 322 displaces an amount of the plug 318 away from the formation face and then initiates a fracture into the subterranean formation according to the present invention.

In one aspect, as described in U.S. Pat. No. 8,141,638 a diverting tool 314 may be connected to the end of the tubing 302 by a tubing connector to divert the fracturing treatment 322 in a direction generally perpendicular to the longitudinal axis for the tool, rather than out the end of the tubing 302, thus initiating a fracture adjacent to the side of the tool. The structure of a flow diverter diverts flow from the middle of the tubing 302 and directs it tangentially out the sides of the tool through slots. The slots may be designed with sufficient flow area so as not to impede the flow of the fluid. The tool 314 does not create a pressure drop nor does it cause any jetting action on the formation itself. The tool uses a solid cone to deflect the fluid tangentially. The end of the tool can have a rounded bullnose to allow the tool to be easily pushed into the well. The tool 314 is not essential to, but improves the ability of, the fracturing fluid to be directed against the formation during the fracturing treatment.

The annulus pressure can be monitored at surface during the fracturing treatment. Pressure may be increased in the annulus to help keep the gel plug 318 in place or the hydrostatic pressure of the fluid 309 (see FIG. 3B) may also perform this purpose.

The rheological properties of the gel are such that migration of the fracturing fluid 322 along the wellbore away from the area of the fracture 324 is minimized due to the yield strength of the gel. Fractures created by the fracturing treatment according to the present invention are thus contained or isolated by the gel plug 318 to or near the area of the diverting tool 314.

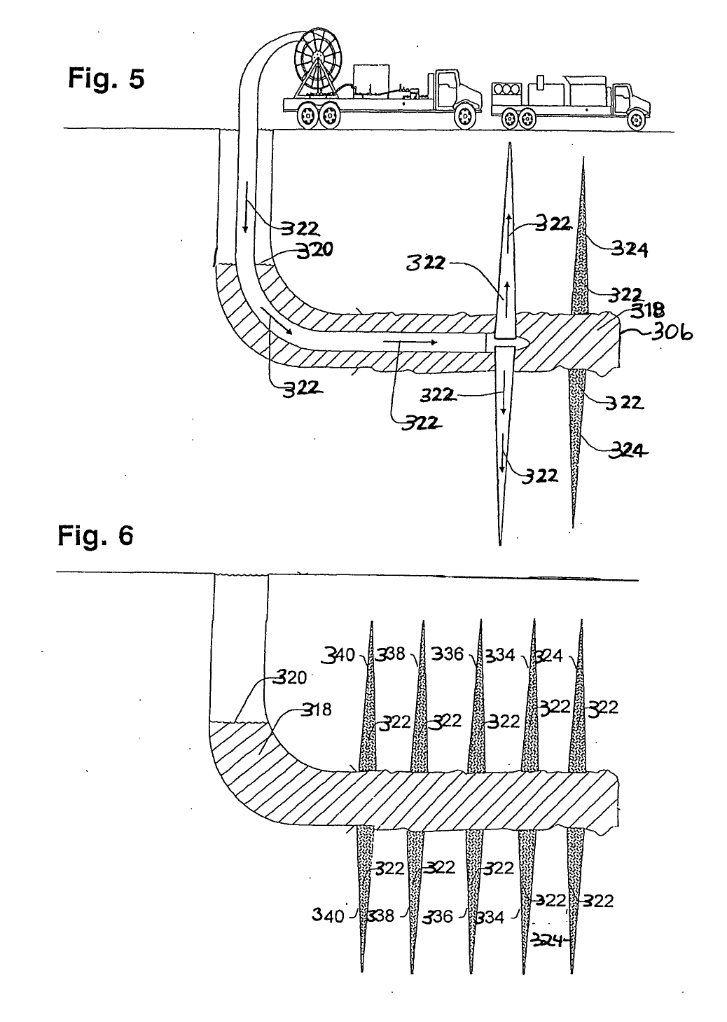

A fracture 324 adjacent the tool 314 is shown in FIG. 3C. After the first fracturing treatment is completed, the tubing 302 is pulled back through the gel plug 318 in the direction of arrow 328 as shown in FIG. 4 towards the heel of the wellbore. If required, additional gel 312 (see FIG. 3B) may be circulated into the wellbore while and/or after the tubing 302 is pulled back to the next interval or location indicated generally at 332 in the formation, where the next fracturing treatment is to be performed. The previously described fracturing method can, according to the present invention, then be performed to create a second fracture in the area of the location 332 (see FIG. 4) as shown in FIG. 5.

This method can be repeated as many times as required in the wellbore (see FIG. 3C). In FIG. 6, five fractures are shown. After all of the desired fracturing treatments have been performed, the tubing 302 is pulled from the wellbore leaving behind the gel plug 318 and the fractures 324, 334, 336, 338 and 340, wherein the fractures 324, 334, 336, 338 and 340 contain fracturing fluid 322 according to the present invention, each optionally with IM according to the present invention.

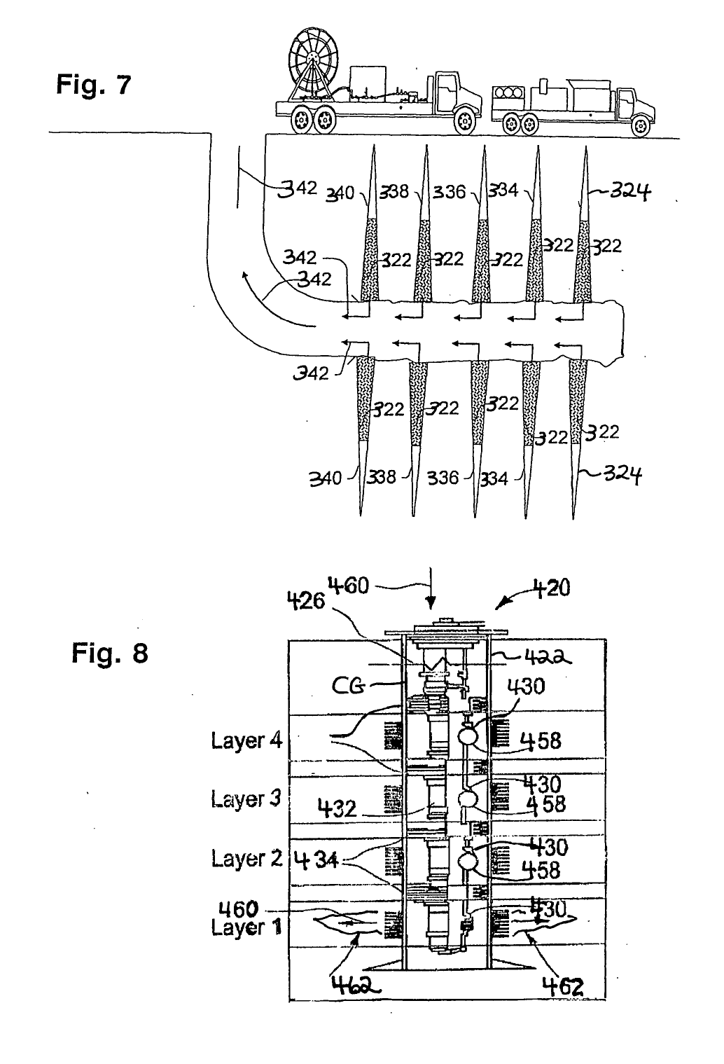

After the elapse of a sufficient amount of time, a gel breaker contained in the gel 312 (see FIG. 3B) causes the viscosity of the gel plug 318 to degrade (break). Once the viscosity degrades to a suitable amount, the well can be flowed back to surface together with the fracturing fluid 322 and oil and gas (not shown) from the formation in the direction indicated by arrows 342 in FIG. 7. The well can be flowed back the day after fracturing is carried out but can be flowed back as soon as the 312 gel breaks which can occur a few hours after the fracturing treatment.

Alternately a chemical breaker may be circulated through the tubing 302 into the wellbore after the final fracture treatment to accelerate the degradation of the gel plug 318 (see FIG. 3C). Optionally, the chemical breaker includes IM according to the present invention for any purpose for IM disclosed herein (any IM disclosed herein suitable for this task and this location).

The method described above can also be used when stimulating a formation below fracturing pressure which is commonly known as a matrix stimulation. In such a matrix stimulations, stimulation fluid according to the present invention with IM according to the present invention (any IM disclosed herein suitable for this task and this location) is used to isolate and inject stimulation fluid at different intervals in a wellbore, to for example, stimulate different formations.

Such stimulation fluid is injected below normal fracturing pressure. The fracturing fluid is diverted into the desired part of the well using the same general method as is described above. A gel plug isolates a certain part of the wellbore and prevents the stimulation fluid from moving to a different part of the well during the treatment. Injected fluids according to the present invention with IM according to the present invention (any IM disclosed herein suitable for this task and this location) can be acid, water, hydrocarbons, solvents, chemical formulations, alcohols, nitrogen, carbon dioxide, natural gas and any other fluid that needs to be confined to a particular area of the wellbore and is designed to stimulate the reservoir.

Referring generally to FIG. 8, a well system 420 according to the present invention is illustrated as deployed in a well 422 to facilitate individual fracturing of a plurality of formation layers 1-4 thereby enhancing hydrocarbon recovery. The well system 420 has a selective injection completion 426 for the controlled injection of fluid into individual, selected formation layers. The completion 426 can provide control over the injection flow, e.g. water injection flow, to individual formation layers via corresponding mandrels/flow control devices 430.

A fraccing fluid 460 according to the present invention with IM according to the present invention, (any such disclosed herein suitable for a particular job and formation) including, but not limited to, e.g. a water-based fracturing fluid), is delivered down a tubing string 432. In a first step, the fraccing fluid 460 is flowed outwardly through the lowermost mandrel 430 and into a lowermost formation zone (“layer 1”) to create desired fractures 462.

The selective injection completion 426 has isolation devices 434, e.g. packers. Optionally, the flow regulators 430 have valves 458, which may be, in one aspect, dummy valves. Such a system, without fluid and without IM according to the present invention, is disclosed in U.S. Patent Application Publication No. 20110198088 (incorporated fully herein for all purposes). The tubing string 432 is deployed within a surrounding casing CG having perforations associated with each formation layer to enable flow of injection fluid from the tubing string 432, through the appropriate flow control device 430, through the corresponding perforations, and into the selected, surrounding formation layer.

Using the system 420, a fracturing process may involve pumping an injection fluid or fluids, e.g. water or another suitable fluid with IM material according to the present invention. Separate fractures at separate levels, each with the same or with a different fracturing fluid according to the present invention, with or without IM or all with IM, can be performed in accordance with the selective string arrangement. The fracturing technique can thus be used to have different fluid in each layer of the formation (e.g., with or without IM) while avoiding communication between formations (assuming material is such as to prevent inter-layer migration of identifiers).

The injection sequence can be repeated for each layer or group of layers of the subterranean region. The valves can be used to block flow into selected layers or formations while one layer is fractured or otherwise stimulated.

After fracturing one layer, another layer is isolated, valves are operated to facilitate isolation and desired flow of fraccing fluid, and fraccing fluid is then introduced to that next layer being fractured. The fraccing fluid 460 can be the same or it can be a different fraccing fluid; and/or the fluid can have the same IM material or it can have a different IM material. As is true of any embodiment herein, the IM may be introduced, fed, poured, or injected via any structure, valve, apparatus or equipment of the system used for the method shown in FIG. 8.

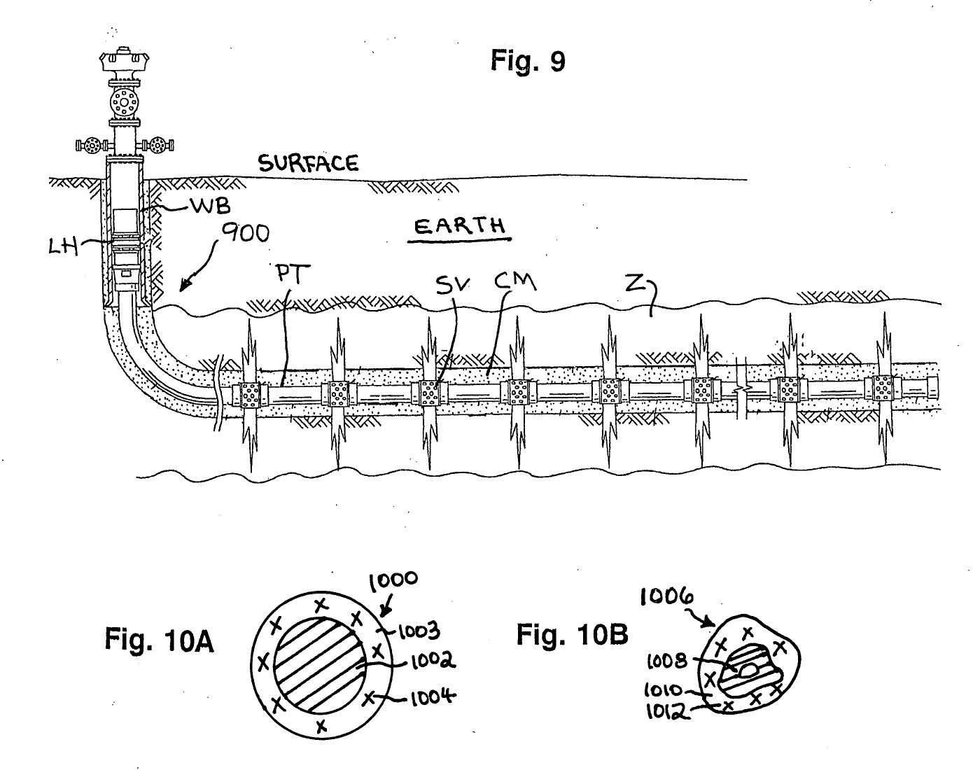

FIG. 9 shows a system 900 according to the present invention in a cemented open hole for the selective fraccing using fluid(s) according to the present invention with IM according to the present invention at different locations along a production tubing. Such a system, but without the benefit of the teachings and suggestions of the present invention, without IM, and without a fluid or fluids according to the present invention with IM, is disclosed in U.S. Pat. No. 7,926,571 (incorporated fully herein for all purposes).

In a producing zone Z, at preselected locations along a production tubing PT, the production tubing has spaced-apart sliding valves SV which can be selectively opened, and cement CM around the sliding valve dissolved. Then the formation may be fracced adjacent the opened sliding valve. By selectively opening different combinations of sliding valves, fraccing can occur in stages, optionally with more fraccing pressure and more fraccing fluid delivered deeper into the formation. The sliding valves can also be selectively closed to protect the production of the well.

The tubing PT extends from a liner hanger LH in a cased wellbore WB. Any known fluid that is pumped through tubing like the tubing PT can be a fluid according to the present invention with IM material according to the present invention, including, but not limited to, fraccing fluids with IM (any according to the present invention), acidizing fluids with IM (any according to the present invention) or other fluids (with IM, any according to the present invention) used in production that can be pumped into the well.

It is within the scope of the present invention for the same fluid to be pumped through each of the valves SV (eight shown, but any desirable number may be used), the fluid being a fluid according to the present invention with IM according to the present invention, in one aspect, a fraccing fluid according to the present invention with IM according to the present invention; or different fluids according to the present invention with different IM can be pumped through different valves.

It is within the scope of the present invention for a wellbore with respect to which a fluid or fluids are used according to the present invention within IM according to the present invention to be vertical, horizontal, or at any desired angle in the earth and this is not limited to the generally horizontal position of the part of the wellbore WB shown in FIG. 9 with the valves SV. Thus a desired fluid may be pumped to any part of a formation through a selected valve and different parts may have fluid pumped therein either in sequence or non-sequentially.

In certain aspects, the present invention provides IM in dry particulate form. As desired, this dry material is added to another material (dry or wet), to a fluid, or to a flowing fluid, so that the IM is usable in any method according to the present invention described herein. In certain aspects, such IM is used in improvements to the subject matter of U.S. Pat. No. 7,972,998, incorporated fully herein for all purposes.

In certain aspects, the present invention provides a method and composition for crosslinking a polymer based fluid including providing a dry blend of IM, crosslinker and delay agent. The IM, crosslinker and delay agent can be mixed and granulated in a dry form prior to addition to the polymer fluid.

In certain aspects, the present invention provides a dry particulate blend capable of crosslinking a polymer fluid, including: any suitable IM according to the present invention; a particulate crosslinker; and a particulate delay agent. Optionally, the polymer fluid is at least one hydratable polymer that has been at least partially hydrated, the particulate delay agent is capable of delaying crosslinking of the at least one hydrated polymer and is one of polyols, sodium gluconate, sorbitol, carbonate salts and combinations thereof, and the dry particulate blend is free of the at least one hydratable polymer. Such a blend according to the present invention with IM may include, one, some or all of the following:

the crosslinker is a boron containing compound;

the particulate crosslinker is one of boric acid, borax, alkaline earth metal borates, alkali earth metal borates and mixtures thereof;

the particulate crosslinker is a zirconium containing compound, a titanium containing compound, at least two or more of a boron containing compound and a titanium containing compound and a zirconium containing compound;

the particulate delay agent is one of sodium gluconate, sorbitol and a combination thereof;

a particulate viscosity stabilizer;

a particulate activator for the crosslinker;

the hydratable polymer is guar;

the guar is a derivatized guar;

the derivatized guar is one of hydroxypropyl guar, carboxymethylhydroxypropyl guar, carboxymethyl guar and combinations thereof;

wherein components are mixed and mixing is batch mixing or on the fly mixing; and/or

wherein crosslinking is delayed for a period of from about 30 seconds to about 15 minutes.

It is within the scope of the present invention also to provide IM in common chemical additives such as antifoaming agents, acids or bases, or other materials or chemicals added to provide appropriate properties to the fluid after it is hydrated. Other additives commonly included in fracturing fluids may also have IM according to the present invention and may include viscosity stabilizers, activators for crosslinking, shear recovery agents, hydration enabling agents and clay stabilizers. Generally, a viscosity stabilizer is an additive used to retard the polymer degradation, e.g., from the effects of temperature, shear and iron exposure.

In one aspect, dry IM according to the present invention is blended with a dry crosslinker and a dry delay agent, all blended or mixed thoroughly in a dry form to produce a blended IM-crosslinker/delay agent compound. The compound may then be formed into granules. Depending on the nature of the components (i.e., the crosslinker and the delay agent) it may be necessary to include a binder to aid in the formation and stability of the granules. The relative proportions of IM, crosslinker, and delay agent as well as the granule size may be adjusted as desired with a particular task, location, or environment in mind.

Dry granulated IM and such IM combined with other components (e.g., crosslinkers and/or delay agents and/or other additives) may be easily stored and transported to a wellsite. In addition, preparation of the fracturing fluid can be simplified, as the dry blend provides Im and additives in a single form, thereby reducing the number of feeds or streams into the fluid. Further the number of operations on location is reduced due to the reduced number of streams. A dry compound is not subject to freezing, thereby facilitating use in colder climates. In addition, the concentration of the components in the dry blend will not change due to evaporation of liquid such as a solvent. This can be particularly beneficial in warmer climates. Yet another advantage of the dry blend is a reduction in the volume and weight of the product, as compared to a liquid additive.

Depending on the specific application in which a compound or mixture according to the present invention with IM according to the present invention will be used, it may be desirable to include any number of additional additives in the compound. As previously mentioned, a binder may be included to aid in the manufacturing of the dry compound. In addition, the compounds may also include a viscosity stabilizer, e.g., a high temperature stabilizer, an activator or a clay stabilizer.

Other fluid additives (with or without IM according to the present invention) may be combined in dry form to produce a single dry and/or granulated additive.

In one embodiment, a method of the present invention includes mixing the polymer fluid and the additive (IM according to the present invention and other components) in a single tank (i.e., batch mixing). The polymer is combined with a liquid and allowed to at least partially hydrate. The additive is then combined with the polymer fluid. Once the fluid and the additive are combined, the fluid may then be pumped downhole.

In another embodiment, the method includes mixing the components “on the fly.” In other words, the components are mixed as the fluid is pumped downhole.

Optionally, dry IM and/or dry crosslinker and/or dry delay agent additive (and/or any other additive) may be added to or combined with a dry polymer. The combined IM, additive(s), and polymer may then be mixed with a suitable liquid stream to produce a polymer based fluid.

In addition to combining IM with a crosslinker and/or delay agent in a dry blend, as previously described, the present invention may include any number of additional dry components blended together to form a single, dry additive. For instance, magnesium oxide, an activator, and sodium gluconate, a delay agent, may be combined in dry form to produce a dry blend for delaying the crosslinking of a polymer fluid.

Embodiments of the present invention include the use of IM (any suitable IM in any suitable amount according to the present invention) with proppants used in fracturing operations to remove hydrocarbons from the earth. It is within the scope of the present invention to use any IM according to the present invention in a proppant body and/or in a coating or encapsulation as disclosed in any of the following U.S. Pat. Nos. 7,073,581; 8,006,755; 7,407,010; 7,931,089; 8,006,759; 7,954,548; 7,950,455; 8,006,754; 8,006,755 7,255,169; 7,784,541; 7,972,998; 8,006,760; 8,061,424; 8,022,015; 7,931,087; 6,691,780; 7,921,010; 6,725,926; 7,516,788; 7,896,068; and 7,153,575 (all incorporated fully herein for all purposes)—and none of these patents, and none of any patent or application cited herein has any teaching or suggestion of using IM as taught by the present invention.

FIG. 10A illustrates a proppant 1000 according to the present invention which has a solid body 1002. The body 1002 may be any known proppant and/or made of any known proppant material or materials. The body 1002 has a coating 1003 with IM 1004 therein (indicated by symbols “X”). The IM material 1004 may be any suitable IM disclosed herein. Neither the body 1002 nor the material 1004 is shown to scale (as is true for all drawings herein). The IM material 1004 may include a combination of multiple different IM materials.

Possible proppant materials for the body 1002 (and any proppant herein) include, but are not limited to, those disclosed herein and disclosed in, those referred to in, and those cited in U.S. Pat. Nos. 7,073,581; 8,006,755; 7,407,010; 7,931,089; 8,006,759; 7,954,548; 7,950,455; 8,006,754; 8,006,755; 7,255,169; 7,784,541; 7,972,998; 8,006,760; 8,061,424; 8,022,015; 7,931,087; 6,691,780; 7,921,010; 6,725,926; 7,516,788; 7,896,068 (all incorporated fully herein for all purposes).

FIG. 10B illustrates a proppant 1006 according to the present invention which has a hollow body 1008 within a coating 1010. The body 1008 may be any known proppant and/or made of any known proppant material or materials. The coating 1010 contains IM material 1012 (indicated by symbols “X”). The IM material 1012 may be any suitable IM material disclosed herein. Neither the body 1008 nor the material 112 is shown to scale. The IM material 1012 may include a combination of multiple different IM materials.

The material 1010 may be any known material for encapsulating, coating, or enclosing a proppant, including, but not limited to, those disclosed in, referred to in, or in citations in any patent listed or mentioned herein.

Material used for encapsulation, coating, and/or enclosing a proppant may be a delay encapsulation or a release encapsulation, etc. that provides release of the IM material, e.g.: time release; release upon contacting a certain material, substance or chemical; release upon change in a certain parameter; or release upon the occurrence of an event.

All patents and applications referred to herein are incorporated fully herein for all purposes.

Each and every invention disclosed herein and in the subject matter of the claims that follow; and in these claims “IM” is any suitable IM according to the present invention:

What is claimed is:

1-20. (canceled)

21. A method comprising:
providing a treatment fluid for earth operations,
the treatment fluid including an effective amount of inhibiting material for inhibiting the production of hydrogen sulfide by bacteria which the treatment fluid encounters.

22. The method of claim 21 wherein the treatment fluid further comprises a gelling agent and an aqueous base fluid; and the method further includes
introducing the treatment fluid into a subterranean formation at a rate and pressure whereby a fracture is formed in the subterranean formation.

23. The method of claim 21 wherein the method is a method of treating a subterranean formation using the treatment fluid, the subterranean formation penetrated by a wellbore, the method further comprising:
preparing the treatment fluid by admixing a gelling material to a hydrating liquid to prepare the treatment fluid;
adding the inhibiting material to the liquid, before or after any other step of the method, in either liquid or dry form, or in both liquid and in dry form,
hydrating the gelling material; and
introducing the treatment fluid to the wellbore at a temperature and a pressure sufficient to treat the subterranean formation.

24. The method of claim 21 wherein the treatment fluid includes an additive which is one, two, some in any combination, or all of crosslinker, viscosifier, buffer, delaying agent, breaker, water wetting control agent, salt clay control agent, biocide, scale inhibitor, surfactant, proppant, pH adjuster, stabilizer, and clay stabilizer.

25. The method of claim 21 wherein the treatment fluid includes a gelling material which is a polymer, polysaccharide, a guar, or a guar derivative, a guar powder which is one of a de-polymerized fast-hydrating high-viscosity guar powder, a derivative of the fast-hydrating high-viscosity guar powder, hydroxy propyl guar powder, carboxy methyl guar powder, and carboxy methyl hydroxy propyl guar powder.

26. The method of claim 21 wherein the treatment fluid contains proppant and the treatment fluid is for use in treating subterranean formations, the treatment comprising a fracture or stimulation.

27. the method of claim 21 wherein the treatment fluid is a fracturing fluid comprising
water;
sand;
additive;
proppants; and
the water, sand, proppants and/or additive having the inhibiting material.

28. the method of claim 21 wherein the treatment fluid is a fracturing fluid, the method including
a drying step producing a dried guar, dried guar derivative, and/or a dried guar substitute), and
the method further comprising
prior to the drying step, the inhibiting material is added to material to be dried, in either dry form or in liquid form.

29. The method of claim 21 wherein the treatment fluid is a fracturing fluid containing proppants, and the proppants include a coating with inhibiting material,
the coating for providing quick activity of the inhibiting material in inhibiting hydrogen sulfide production upon arrival at a location of interest or for delayed or residual effect.

30. The method of claim 21 wherein the inhibiting material is present at a level such that the inhibiting material is not expended in an operation.

31. The method of claim 21 wherein the inhibiting material is present in an amount in the range of about 1 to about 50 pounds per 1,000 gallons of the treatment fluid.

32. The method of claim 21 wherein the inhibiting material is present in an amount of about 1 pound of per 1,000 gallons of treatment fluid.

33. The method of claim 21 wherein the inhibiting material is present from about 0.001 to about 2.0% by weight of treatment fluid.

34. The method of claim 21 wherein the inhibiting material is present as about 5 to 25 parts per million of treatment fluid.

35. The method of claim 21 wherein the inhibiting material is present as about 100 parts per million of treatment fluid.

36. The method of claim 21 wherein the inhibiting material is present as about 250 parts per million of treatment fluid.

37. The method of claim 21 wherein the inhibiting material is present as about 500 parts per million of treatment fluid.

38. The method of claim 21 wherein the inhibiting material is present as 0.001 of 1 gallon of prepared fluid which is about 50% water, about 50% inhibiting material by weight, this prepared fluid mixed with about 1000 gallons of additional fluid.

39. The method of claim 21 wherein the one gallon of the treatment fluid is about 15% by weight inhibiting material or includes about 12 pounds of inhibiting material, or is between 7 to 25 ppm inhibiting material.

40. A treatment fluid comprising: a base fluid and inhibiting material which inhibits the production of hydrogen sulfide by bacteria.
